(19) United States
(12) Patent Application Publication
(10) Pub. No.: US 2003/0168402 A1
(43) Pub. Date: Sep. 11, 2003

(54) Fluid treatment system and apparatus

(75) Inventor: Allen McKay, Fargo, ND (US)

Correspondence Address: Jay F. Moldovanyi, Fay, Sharpe, Fagan, Minnich & McKee, LLP, 7th Floor, 1100 Superior Avenue, Cleveland, OH, 44114-2518, US

(73) Assignee: Webb Inc.

(21) Appl. No.: 10/373,288

(22) Filed: Feb. 24, 2003

Related U.S. Application Data
(60) Provisional application No. 60/360,838, filed on Feb. 28, 2002.

(51) Int. Cl. B01D 17/038

(52) U.S. Cl. 210/512.1; 210/87; 210/175; 210/304; 210/512.3

(57) ABSTRACT

A fluid treatment apparatus for an internal combustion engine of a vehicle includes a fluid supply line leading from a fluid supply tank of an associated engine and a fluid pretreatment device communicating with the fluid supply line. The fluid pretreatment device includes a housing, a conical structure extending in the housing, a collection cup supported on the housing, and a draw tube. The housing includes a wall, and the wall cooperates with the conical structure to define a particle separation chamber in the housing for separating particles from a fluid flowing through the separation chamber to produce a pre-cleaned fluid. The collection cup receives and holds the particulate matter separated from the fluid in the particle separation chamber. The draw tube extends into the particle separation chamber for leading the pre-cleaned fluid back to the fluid supply line.

This application claims the benefit of U.S. Provisional Application No. 60/360,838 filed Feb. 28, 2002, the entire disclosure of which is incorporated herein by reference.

### BACKGROUND OF THE INVENTION

The present invention relates generally to the art of fluid treatment systems and devices and, more particularly, to fluid treatment systems and devices that utilize cyclonic fluid flow to separate foreign particles and immiscible fluids from the fluid being treated. It finds particular application in conjunction with the treatment of fluids used in association with internal combustion engines, such as fuel and engine coolant, for example, and will be described with particular reference thereto. However, it is to be appreciated that the fluid treatment device of the present invention is similarly useful in other applications, such as where the removal of solid particulates is desirable to minimize blockage and clogging of a downstream filter. Accordingly, it is to be distinctly understood that the present invention is not intended to be limited to the treatment of fuel and/or coolant. Rather the present invention is suitable for treating a wide variety of fluids in any suitable application.

Fluid filtering devices have been provided heretofore and, generally, are known to include a filter housing formed from at least one housing wall that defines a filter cavity therein. A fluid inlet and a fluid outlet each extend through the housing wall, and a particulate filter element is secured within the housing chamber. The filter element is positioned within the housing such that fluid flowing into the filter through the inlet passes through the filter element to reach the outlet of the filter. Being unable to pass through the filter element, the foreign particles are trapped and retained within the filter element separating such particles from the fluid. However, it is well known that the build-up of these foreign particles eventually clogs the filter element, which reduces the capacity of the filter to allow fluid to pass therethrough. Reduced fluid flow through the filter can cause a reduction in the performance of an associated device, such as an engine or pump, for example, and may ultimately result in a completely clogged filter which can render the associated device inoperable or, in some cases, cause damage to the device.

The need to separate water and other immiscible fluids from a fluid such as gasoline or diesel fuel, for example, is well known. Water is unavoidably found in fuel reservoirs of vehicles, such as truck tractors. It can cause rust particles to form and flake from iron components, cause microbial growth that forms sludge, and can mix with sulfur creating sulfuric acid which washes away natural lubricants of the fuel. These conditions can accelerate wear and erosion of internal engine components and injectors or create premature failure of the fuel filter. As such, it is desirable to develop fluid treatment devices that separate water and other immiscible fluids from such fuels as well as remove foreign particles such as rust flakes and sludge from the fuel, but which avoid the disadvantages of using particulate filters as the only means of fuel filtering.

It is also desirable to separate foreign particulates from these and other fluids, including coolant used in vehicles. Some known vehicles have large capacity cooling systems, such as heavy-duty mining equipment, off-road tractors, and class 8 trucks, for example. Such vehicles, in particular, often have radiators and other heat exchangers manufactured using a sand casting process. As a result of this process, residual sand is often picked up by the coolant fluid and carried through the coolant system. Such sand can abrade or otherwise damage components of the vehicle. Other foreign particulates and contaminates are also found in these cooling systems, including scale, sludge and additives, such as SCA (supplemental coolant additive) and/or other additives that are used to retard cavitation and erosion, that have precipitated out of the coolant.

Additionally, the use of certain fluids, especially fluids such as diesel fuel, is problematic in low temperature environments. For example, low temperatures can cause diesel fuel to thicken and become viscous. The pumping of a thick and viscous diesel fuel through a transfer system and into an engine can be difficult and result in an undue burden being placed on the engine components. Also, cold diesel fuel is harder to ignite in the combustion chamber of an engine. Furthermore, any water present in the diesel fuel can freeze and block the flow of fuel supplied to the engine. As such, it is generally desirable to warm the fuel before it is delivered to a combustion chamber of an engine. Generally, fluid warming devices are known to those skilled in the art.

Fluid heating and separating devices have been provided heretofore and, generally, are known to include a heating assembly, a de-moisturizing assembly and a filter assembly. The de-moisturizing assembly typically is supported below the heating assembly such that water and other immiscible fluids may be separated from the fluid being treated. The heating assembly has a body through which heat is transferred into or out of the fluid. The filter assembly is supported on top of the body of the heating assembly and includes a particulate filter element for removing the remaining foreign particulates from the fluid. In operation, fluid enters the fluid heating and separating device through the fluid inlet port, travels into the de-moisturizing assembly where water and other immiscible fluids as well as larger foreign particles are separated from the fluid being treated. Typically, the apparatus is mounted on a suction side of a fluid system (i.e., before the fluid pump). However, it could be mounted on the pressure side of the system, downstream from the fluid pump. Thus, the fluid could be pressurized or under suction. The de-moisturizing assembly typically includes a collection cup having a collection chamber for receiving and retaining the water and other immiscible fluids and foreign particles separated from the fluid. A drain valve extends through the collection cup for emptying the water and other fluids and foreign particles separated from the fluid that have been retained in the collection chamber. The fluid is fed up through the body of the heating assembly into the filter assembly and passes through a filter element retained therein, which further separates any remaining foreign particles from the fluid. The filtered, de-moisturized and heated fluid is then discharged through a fluid outlet port and delivered downstream, such as to an engine or pump, for example.

As indicated in the foregoing discussion, known fluid treatment devices typically include a particulate filter element that tends to become clogged from the rust, sludge and other particles removed from the fluid being treated. As such, the filter element in these fluid treatment devices causes a reduction in output of the overall fluid treatment device. Reduced fluid flow through the fluid treatment apparatus causes an undesirable reduction in performance or operation of the associated downstream device, such as an engine or pump, for example. Accordingly, it is desirable to provide an effective and efficient fluid treatment system that utilizes one or more de-moisturizing, warming and filtering devices while minimizing the disadvantages found in particulate filter elements.

Another disadvantage of known fluid treatment devices is the great variation in capacity and mounting arrangements that can exist from application to application. Turning to fuel treatment apparatuses for internal combustion engines, for example, it is well known that internal combustion engines are available in a wide variety of displacements, power outputs and configurations. As such, both the fuel flow and mounting requirements of fuel treatment apparatuses vary widely. The time and expense of developing, manufacturing and obtaining approval from the engine manufacturer for new fuel treatment systems is significant. And, continual conflicts arise regarding specific engine installs during this lengthy approval process due to the constantly changing filter requirements. Furthermore, the resulting fuel treatment devices may be overly complicated or have complex mounting arrangements in an attempt to meet the requirements of several engine manufacturers.

Accordingly, it is desirable to develop and provide a compact, highly efficient and lower cost fluid treatment system that is suitable for use in treating various types of fluid. It is also desirable to provide a fluid treatment system having a simplified and more uniform mounting arrangement adapted for use on multiple engine sizes and configurations in each of the numerous vehicle classes. Furthermore, it is desirable to provide a fluid treatment system and apparatus which filters, de-moisturizes and optionally warms the fluid being treated and which overcomes the foregoing deficiencies and others, while meeting the above-stated needs and providing better and more advantageous overall performance.

### BRIEF SUMMARY OF THE INVENTION

A fluid treatment apparatus according to the present invention includes a housing that has a first wall at least partially defining a particle separation chamber. The housing further includes a housing axis and a fluid inlet passage that extends through the first wall of the housing in tangential relation to the particle separation chamber. The fluid treatment apparatus also includes a second wall disposed within the housing, and a draw tube protruding into the housing and extending generally along the housing axis. The second wall includes a conical portion with the housing axis extending through the conical portion. The draw tube includes a tubing wall that at least partially defines a fluid outlet passage.

Also, a fluid treatment apparatus for use with an internal combustion engine is provided that includes a fluid manifold, a housing supported on the manifold, a separation cone supported at least partially in the housing, and a draw tube. The manifold includes a fluid transfer passage that extends through at least a portion of the manifold. The housing includes a housing wall at least partially defining a particle separation chamber, a housing central axis, and a fluid inlet passage that extends through the housing wall in tangential relation to the particle separation chamber. The separation cone cooperates with the housing wall, and the draw tube defines a fluid outlet passage that communicates with the fluid manifold and includes a proximal end located adjacent the separation cone.

Additionally, a fluid treatment apparatus is provided that includes a fluid manifold, a fluid filter selectively supported on the manifold, a housing supported on the manifold in spaced relation to the fluid filter, a vortex breaker supported at least partially in the housing, and a collection cup supported by the housing for holding particulate matter separated from the fluid. The manifold includes a transfer passage. The housing includes a wall cooperating with a conical structure at least partially located within the housing to define a particle separation chamber. The chamber includes a generally vertically extending axis, and the housing includes a fluid inlet passage extending through the housing wall in a generally tangential relation with the separation chamber such that the fluid passing through the fluid inlet passage undergoes cyclonic flow in the separation chamber. The vortex breaker includes a body portion and at least one counter-flow surface extending from the body portion.

Furthermore, a fluid treatment apparatus for an internal combustion engine of a vehicle is provided that includes a fluid supply line leading from a fluid supply tank of an associated vehicle to an engine thereof, and a fluid pretreatment device communicating with the fluid supply line. The fluid pretreatment device includes a housing, a conical structure extending within the housing, a collection cup supported on the housing, and a draw tube. The housing includes a housing wall that cooperates with the conical structure to define a cyclonic particle separation chamber in the housing for separating particles from a fluid flowing through the separation chamber to produce a pre-cleaned fluid. The collection cup holds the particulate matter separated from the fluid in the particle separation chamber, and the draw tube extends into the particle separation chamber for leading the pre-cleaned fluid back to the fluid supply line.

### BRIEF DESCRIPTION OF THE DRAWINGS

The invention may take form in certain components and structures, preferred embodiments of which will be illustrated in the accompanying drawings in which:

FIG. 1 is a schematic illustration of a conventional fluid transfer system;

FIG. 2 is a schematic illustration of a fluid treatment system in accordance with one embodiment of the present invention, shown in use as a part of a fluid transfer system of a vehicle;

FIG. 3 is a perspective view of the fluid treatment system of FIG. 2;

FIG. 4 is a perspective view of a fluid treatment device of the system of FIG. 3;

FIG. 5 is a perspective view of a vortex housing and draw tube of the device of FIG. 4;

FIG. 6 is a partial cross-sectional view of the vortex housing and draw tube of FIG. 5;

FIG. 7 is a schematic illustration of another embodiment of a fluid treatment system in accordance with the present invention, shown installed in use as a part of a fluid transfer system of a vehicle;

FIG. 8 is a perspective view of still another embodiment of a fluid treatment system in accordance with the present invention;

FIG. 9 is a section view of the fluid treatment system of FIG. 8 taken along line 9-9;

FIG. 10 is a faceplate of a restriction indicator used in association with the fluid treatment system of FIG. 8;

FIG. 11 is a rear elevation view of the fluid treatment system of FIG. 8 shown without a secondary filter;

FIG. 12 is a perspective view of an alternate embodiment of a vortex breaker for use with a fluid treatment apparatus of the present invention;

FIG. 13 is a section view of coolant passages and a thermostat/valve arrangement of the transfer rail shown in FIG. 8 taken along line 13-13;

FIG. 14 is a front elevation view of a further embodiment of a fluid treatment system in accordance with the present invention;

FIG. 15 is a top plan view of the fluid treatment system of FIG. 14;

FIG. 16 is a schematic illustration of fluid flow and particle separation through the fluid treatment devices of FIGS. 8, 9, 11 and 14.

### DETAILED DESCRIPTION OF THE PREFERRED EMBODIMENTS

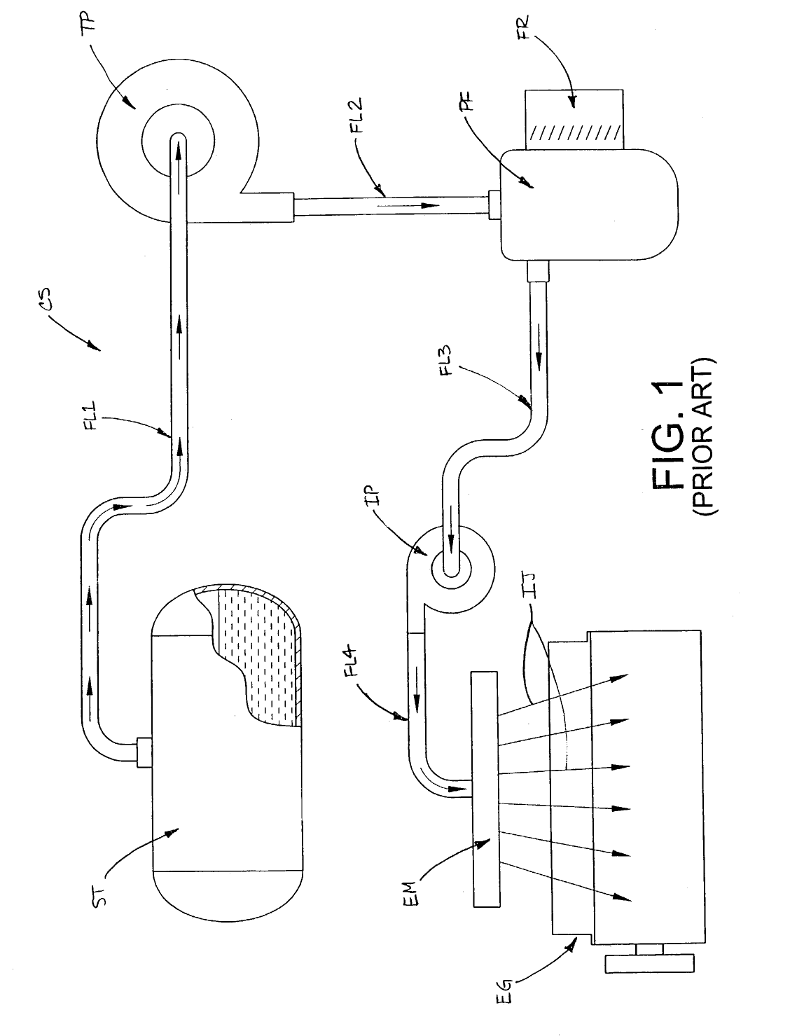

FIG. 1 schematically illustrates a conventional fluid transfer system of a vehicle, such as a truck tractor, which is powered by an internal combustion engine operating on a fluid, such as diesel fuel. Such transfer systems are generally known by those skilled in the art, and the following discussion of FIG. 1 is merely provided to establish background environment and terminology for further discussion of the preferred embodiments of the present invention.

A conventional fluid transfer system CS is operatively associated with a vehicle (not shown) that has one or more supply tanks ST containing a fuel, such as diesel fuel. A lift or transfer pump TP generates a suction force that draws fuel out of tank ST along a first fluid supply line FL1 and into the transfer pump. The fuel is pressurized and output by transfer pump TP through a second fluid supply line FL2 and delivered into a particulate filter PF. The particulate filter is commonly positioned within the fluid transfer system such that pressurized fuel from the transfer pump is delivered thereto, as illustrated in FIG. 1. However, it will be appreciated that in certain applications the particulate filter may be positioned upstream of the transfer pump and would, therefore, be used under vacuum. Filtered fuel is discharged from particulate filter PF through a third fluid supply line FL3 and delivered into an injection pump IP which outputs high pressure fuel to an engine manifold EM through a fourth fluid supply line FL4. The engine manifold delivers the fuel into the combustion chambers of an engine EG through injectors IJ. In known fluid transfer systems, transfer pump TP, particulate filter PF and injector pump IP, as well as engine manifold EM and engine EG, are all typically supported within or adjacent the engine compartment (not shown) of the vehicle (not shown). As such, particulate filter PF is commonly mounted on a frame rail FR within the engine compartment. It will be appreciated that such mounting arrangements take up valuable space along the frame rail and commonly result in the need for different installation hardware and fluid supply lines for each of the many vehicle/engine combinations. It will be further appreciated that particulate filters and mounting arrangements therefor, such as spin-on mounting arrangements, are well known in the art. Additionally, particulate filter PF shown in FIG. 1 may be replaced by a combination water separator and filter device, as are commonly known in the art.

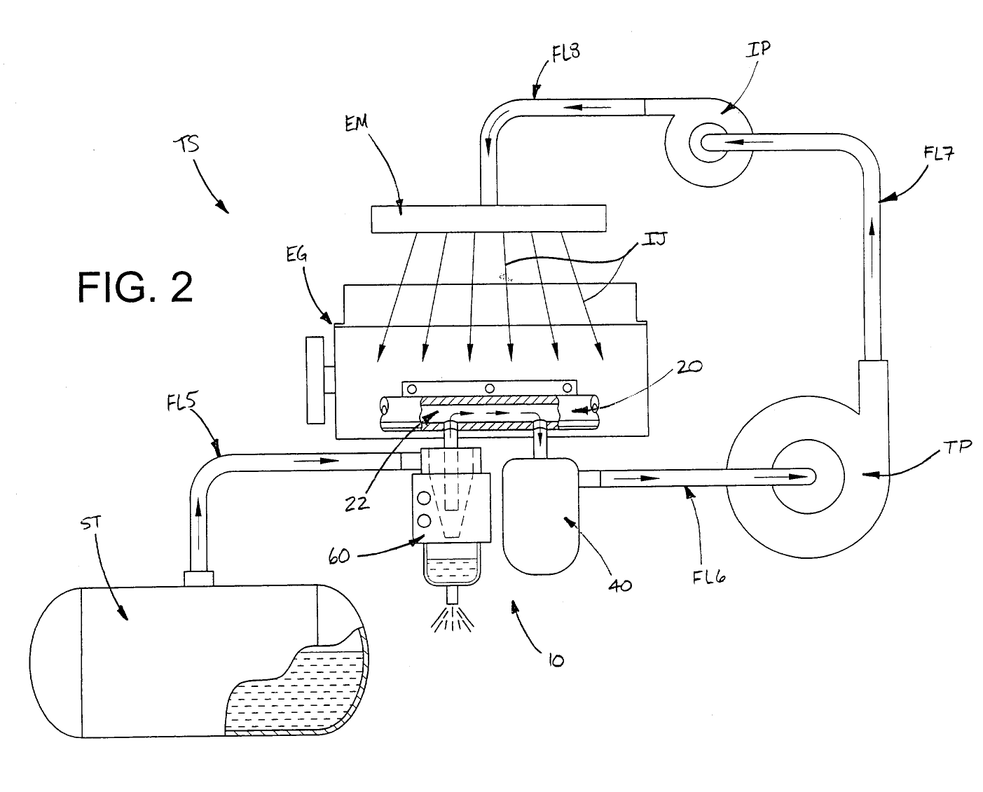

Referring now in greater detail to the drawings, wherein the showings are for the purpose of illustrating preferred embodiments of the invention only, and not for the purpose of limiting the invention, FIG. 2 illustrates a fluid transfer system TS according to one embodiment of the present invention. Transfer system TS employs a fluid treatment system 10 to deliver filtered, de-moisturized and, optionally, heated fluid, such as diesel fuel, to a downstream device or apparatus, such as an internal combustion engine EG used in a truck tractor (not shown). A supply tank ST stores a supply of fluid, such as diesel fuel. A first fluid supply line FL5 extends from tank ST to fluid treatment system 10, and a second fluid supply line FL6 extends from fluid treatment system 10 to a lift or transfer pump TP. A third fluid supply line FL7 extends from transfer pump TP to an injector pump IP, and a fourth fluid supply line FL8 extends from injector pump IP to an engine manifold EM of engine EG. The fuel is thereafter delivered to engine EG by injectors IJ. Typically, supply tank ST is supported on the exterior of the vehicle (not shown), while fluid treatment system 10, transfer pump TP, injector pump IP, as well as the engine manifold EM, injectors IJ, and engine EG are supported within the engine compartment (not shown) of the vehicle (not shown). As shown in FIG. 2, fluid treatment system 10 is preferably supported on engine EG, as opposed to other common mounting surfaces or members, such as frame rail FR illustrated in FIG. 1.

In operation, the fluid transfer system delivers fuel from supply tank ST to the combustion chambers of engine EG through injectors IJ. Transfer pump TP generates a suction action along first and second fluid supply lines FL5 and FL6, as well as through fluid treatment system 10 which includes a fluid manifold or transfer rail 20, a secondary filter 40 and a primary fluid treatment apparatus 60. As such, fuel is drawn into first fluid supply line FL5 from supply tank ST and into fluid treatment apparatus 60 of the fluid treatment system. The fuel is drawn through treatment apparatus 60, into and along transfer rail 20, and is delivered into secondary fuel filter 40. The filtered, de-moisturized and optionally heated fuel is drawn out of filter 40 through second fluid supply line FL6 and into transfer pump TP. The transfer pump outputs pressurized fuel to injector pump IP through third fluid supply line FL7, which in turn delivers high pressure fuel to engine manifold EM through fourth fluid supply line FL8. The engine manifold delivers high-pressure fuel to the combustion chambers of engine EG through injectors IJ. Fluid treatment system 10 is positioned upstream of transfer pump TP causing the system to be subjected to vacuum rather than pressure. However, it will be appreciated that in certain situations or installations some components of the system, namely, the secondary filter, may be positioned downstream of the transfer pump, though the filter itself may remain mounted on the engine, such as on the transfer rail, for example.

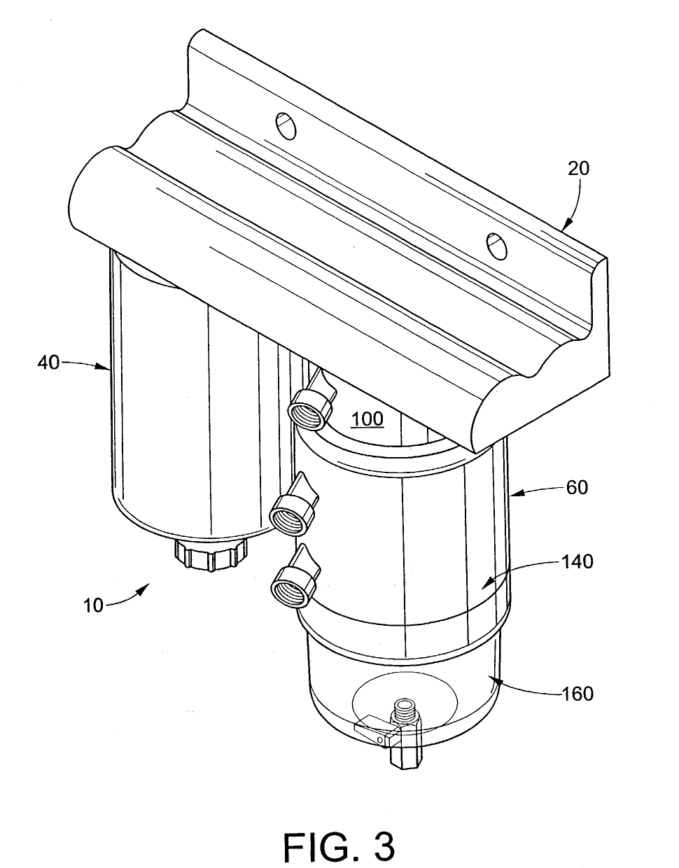

With reference now to FIG. 3, fluid treatment system 10 includes fluid manifold or transfer rail 20, secondary filter 40 supported on transfer rail 20, and primary fluid treatment apparatus 60 for separating water and other immiscible fluids, as well as foreign particles, from the fluid being treated and optionally heating the same. Transfer rail 20 includes at least one transfer passage 22 (FIG. 2), and it will be appreciated that certain applications may benefit from additional transfer passages. Transfer rails, such as fuel rails, for example, are generally well known in the art and are typically supported on or near a downstream device, such as the engine of a vehicle to which a fluid, such as fuel, is to be supplied. Likewise, secondary filters 40 are also well known in the art, and preferably include “screw-on” type mounting arrangements in which the fluid inlet and outlet extend generally co-linearly with the axis of the filter body. Such filters are typically installed along the fluid delivery path upstream of the device, such as an engine, to which the fluid, such as diesel fuel, is ultimately to be delivered. Primary treatment apparatus 60 is supported on transfer rail 20 upstream of the secondary filter 40 and attaches to the transfer rail in any suitable manner and in a generally vertical orientation. For example, the treatment apparatus can be welded onto the transfer rail. However, other suitable arrangements may be used, such as using a male threaded stem on the transfer rail and a threaded mounting hole in the treatment apparatus. It will be appreciated that one or more check valves (not shown), either internal, external or both, may be included within system 10 or the components thereof, such as treatment apparatus 60, to guard against the loss of prime, such as when the system is undergoing maintenance or other service, for example.

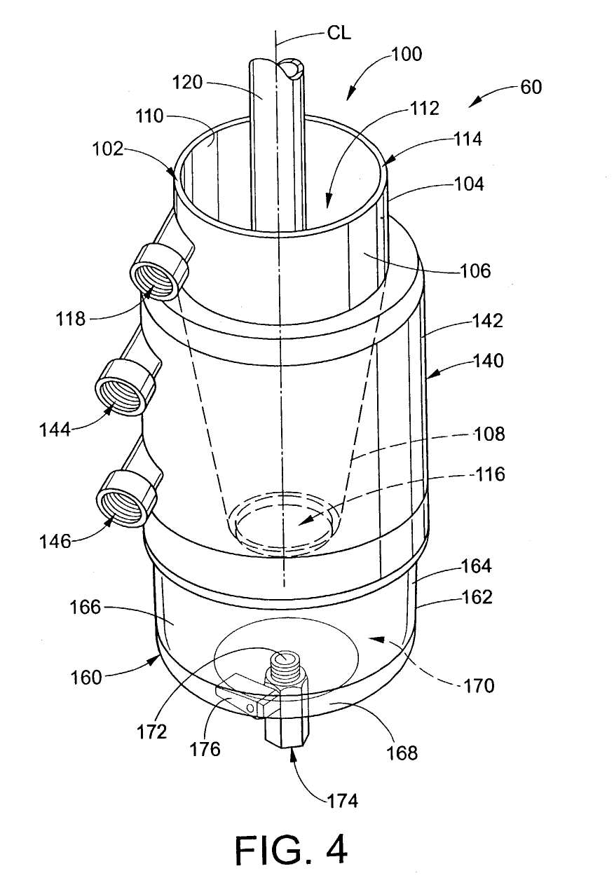

As shown in FIG. 4, fluid treatment apparatus 60 includes a separating assembly 100, a heating assembly 140, and a collection assembly 160. Separating assembly 100 includes a vortex housing 102 and a draw tube 120. Heating assembly 140 includes a fluid jacket 142 that extends circumferentially around at least a portion of vortex housing 102. Fluid jacket 142 can be formed from aluminum due to the material's excellent heat transfer properties and ease of manufacturing, though it will be appreciated that other suitable materials can be used. Fluid jacket 142 includes a coolant intake port 144 and a coolant return port 146. A plurality of fluid passages (not shown) extends through fluid jacket 142 connecting ports 144 and 146. As such, engine coolant from an associated vehicle or other source can be circulated through the fluid passages to transfer heat into fluid jacket 142 which in turn transfers heat into the fluid passing through fluid treatment apparatus 60. It will be appreciated, however, that jacket 142 can be heated by an alternate source, such as an electrical heat source, rather than using engine coolant. Additionally, it will be appreciated that such an alternate heat source may be used in addition to the coolant, such as to provide pre-heating to jacket 142. Furthermore, heating assembly 140 can include a thermostat (not shown) to automatically regulate temperature, such as to cool fluid during the summer and warm fluid during the winter, for example.

Collection assembly 160 includes a collection cup 162 supported on jacket 142 below at least a portion of each of heating assembly 140 and separation assembly 100. Collection cup 162 receives and retains the water and other immiscible fluids as well as foreign particles that are separated from the fluid being treated by separation assembly 100. Collection cup 162 is formed from at least one wall 164 defining a collection cavity 170 therein. The at least one wall has a side wall portion 166 and a bottom wall portion 168, and can be formed from a transparent material. A purge passage 172 extends through bottom wall portion 168. Passage 172 is outfitted with a purge valve 174 which forms a fluid tight seal with bottom wall portion 168 to permit the selective evacuation of the water and other immiscible fluids as well as foreign particles from collection cavity 170. Purge valve 174 is shown in FIGS. 1 and 2 as having a handle 176 for manually opening and closing the valve such that cavity 170 may be drained on an as-needed basis, such as daily, weekly or monthly as fluid quality and other factors dictate. Additionally, it will be appreciated that the valve may be opened and closed by remote actuation or automatically, for example, in response to level sensors responsive to the quantity of fluids and particles in collection cavity 170.

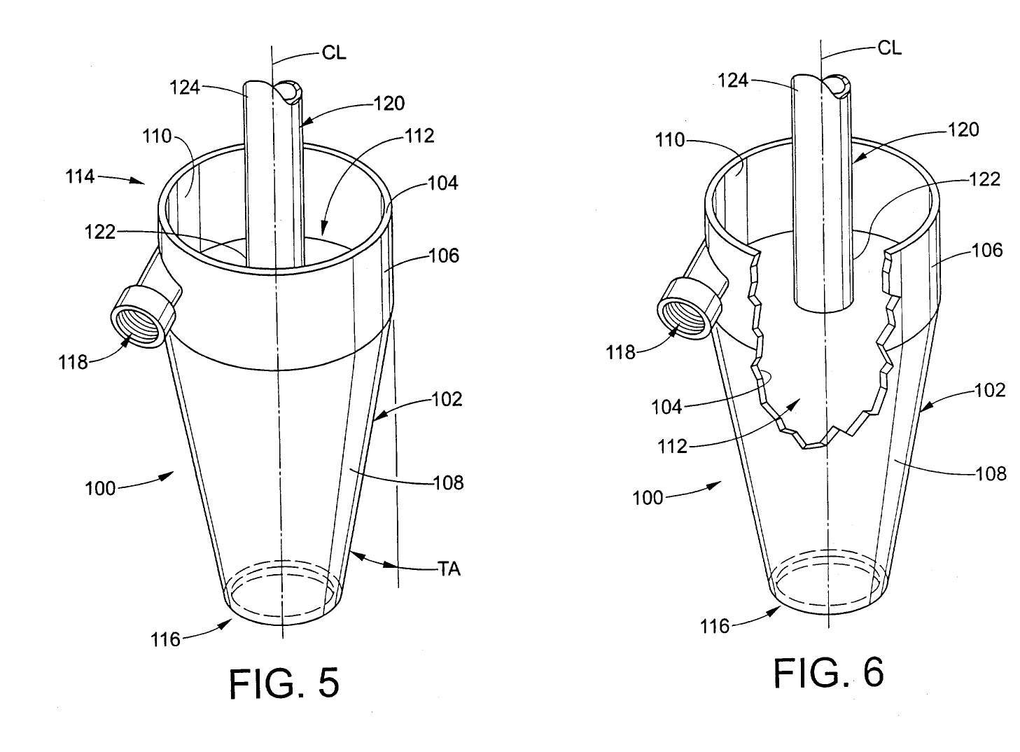

With reference now to FIG. 5, vortex housing 102 of separation assembly 100 is formed by a circumferentially extending wall 104 having a cylindrical upper wall portion 106 and a frustoconical lower wall portion 108. The frustoconical lower wall portion extends at a tapered angle TA of about ten to about twenty degrees (10°-20°). Wall 104 has an inside surface 110 defining a cyclonic separation or treatment chamber 112 that extends between an open upper end 114 adjacent cylindrical wall portion 106 and an open lower end 116 adjacent frustoconical wall portion 108. Circumferential wall 104 defines a central axis CL that preferably extends generally vertically. A generally horizontal fluid intake port 118 is radially spaced from central axis CL and extends through cylindrical wall portion 106 of wall 104 forming a generally tangential inlet opening to inside surface 110. Draw tube 120 extends generally coaxially along central axis CL, and has a pickup end 122 (FIG. 6) and a delivery end 124. Pickup end 122 extends into chamber 112 of vortex housing 102, and delivery end 124 projects from the vortex housing and includes a fluid-tight connection, such as threads (not shown), adjacent the delivery end for interfacing with transfer rail 20.

With reference again to FIG. 3, threaded stems (not shown) are preferably supported on transfer rail 20 to which treatment apparatus 60 and secondary filter 40 can be attached in a fluid-tight manner. To provide application and installation flexibility, the threaded stem can include numerous diameters forming generally cylindrical steps axially along the length of the stem. A plurality of the diameters having threads, each with a different pitch diameter, for connecting with a component of fluid treatment system 10, such as transfer rail 20, secondary filter 40 and treatment apparatus 60. It will be appreciated that the various threaded portions may have different pitches or thread forms. For example, one portion of the stem may have a tapered pipe thread and an adjacent portion may have a straight thread.

With reference again to FIG. 4, in operation, such as along a fuel supply system of a vehicle, untreated fuel, from a supply source, such as supply tank ST (FIG. 2), is delivered to fluid treatment system 10 via first fluid supply line FL5 (FIG. 2) which forms a fluid-tight connection with intake port 118 of fluid treatment apparatus 60. The fluid enters chamber 112 of vortex housing 102 in separation assembly 100 through intake port 118. The tangential inlet of the fluid initiates a cyclonic action by flowing approximately one revolution around inside surface 110 of vortex housing 102 along cylindrical wall portion 106 before entering the frustoconical wall portion 108. The continued rotation of the fluid causes water droplets and other immiscible fluids as well as foreign particles, such as rust and sludge, for example, which are typically heavier than the fluid, to move radially outwardly toward inside surface 110 of circumferential wall portion 104.

As gravity acts on the fluid, it flows downwardly into frustoconical wall portion 108 of vortex housing 102. The reduction in diameter of inside surface 110 due to the conical nature of frustoconical wall portion 108 causes the rotational speed of the fluid to increase which further urges the water and other foreign matter radially outwardly and away from the fluid. The water and other foreign particles migrate to wall inside surface 110 and flow along this surface. As the fluid being treated and the water and other foreign matter continue to rotate and descend within chamber 112, the separation of these elements continue and a pool of “clean” fluid collects near central axis CL of the chamber. As shown in FIG. 6, pickup end 122 of draw tube 120 extends into this central pool, and the suction action generated by transfer pump TP causes fluid to be drawn out of the central pool through draw tube 120 and delivered through delivery end 124 to transfer rail 20. As shown in FIG. 2, the fluid thereafter is drawn through secondary filter 40 and is ultimately delivered to a downstream device, such as an engine or pump. With reference again to FIG. 4, the water droplets and other immiscible fluids, as well as the foreign particles, continue to flow down along inside surface 110 of frustoconical wall portion 108, out open lower end 116 thereof, and drop into collection cavity 170 of collection cup 162. These foreign products are retained in the collection cavity until being purged through passage 172.

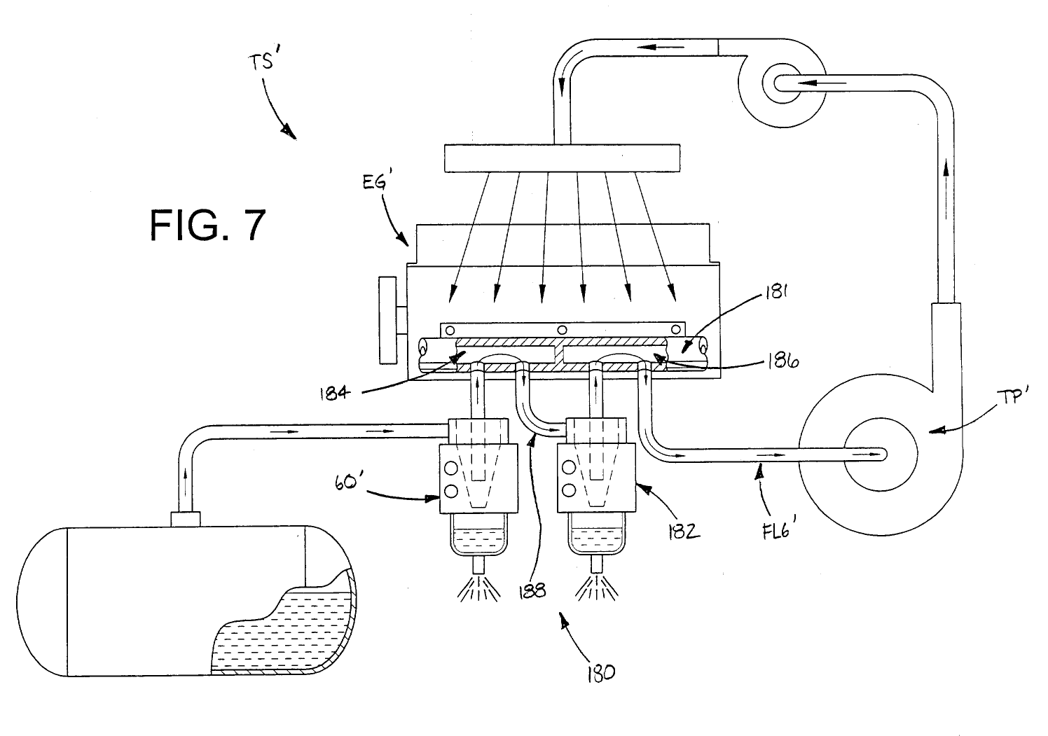

A second embodiment of a fluid transfer system according to the present invention is shown in FIG. 7. In this embodiment, like components are identified by like numerals or letters with a primed (′) suffix and new components are identified by new numerals. Fluid transfer system TS′, shown in FIG. 7, utilizes a fluid treatment system 180 to deliver filtered, de-moisturized and, optionally, heated fluid, such as diesel fuel, to a downstream device or apparatus, such as internal combustion engine EG′ or pump (not shown), for example.

Fuel treatment system 180 includes a fluid manifold or transfer rail 181, a primary fluid treatment apparatus 60′ and a secondary fluid treatment apparatus 182. It will be appreciated that secondary apparatus 182 is used in place of secondary particulate filter 40 shown in FIG. 2. As such, in this embodiment no conventional filter is used in fluid treatment system 180 and, thus, the disadvantages, such as reduced fluid flow and degradation in the downstream device performance, due to filter element clogging is likewise eliminated. It will be further appreciated that primary apparatus 60′ and secondary apparatus 182 are substantially identical, although the secondary apparatus may be adjusted as necessary to better separate any smaller foreign particles that may remain in the fluid exiting the primary apparatus. What's more, depending on the desired temperature of the fluid, either one or both of the primary and secondary apparatuses 60′ and 182 can optionally provide heating to the fluid flowing through fluid transfer system TS′.

As shown in FIG. 7, transfer rail 181 is supported on engine EG′. The transfer rail includes two separate passages 184 and 186 which are fluidically isolated from one another. Transfer rail 20 in FIG. 2 illustrates only one fuel passage 22. However, it will be appreciated that transfer rails are known to have multiple passages for fluid flow, and the illustrated transfer rails 20 and 181 merely illustrate an example of suitable transfer rails, and are not intended to be limited to respectively having one and two fuel passages. Primary and secondary treatment apparatuses 60′ and 182 are supported on transfer rail 181 with the output of each apparatus being respectively delivered into passages 184 and 186 of the transfer rail. A delivery line 188 extends between passage 184 and the input of secondary apparatus 182 to deliver fluid treated by primary apparatus 60′ from passage 184 into secondary apparatus 182 for further treatment. Fluid treated by secondary apparatus 182 and delivered to passage 186 is then drawn into transfer pump TP′ through second fluid supply line FL6′, as discussed with regard to FIG. 2.

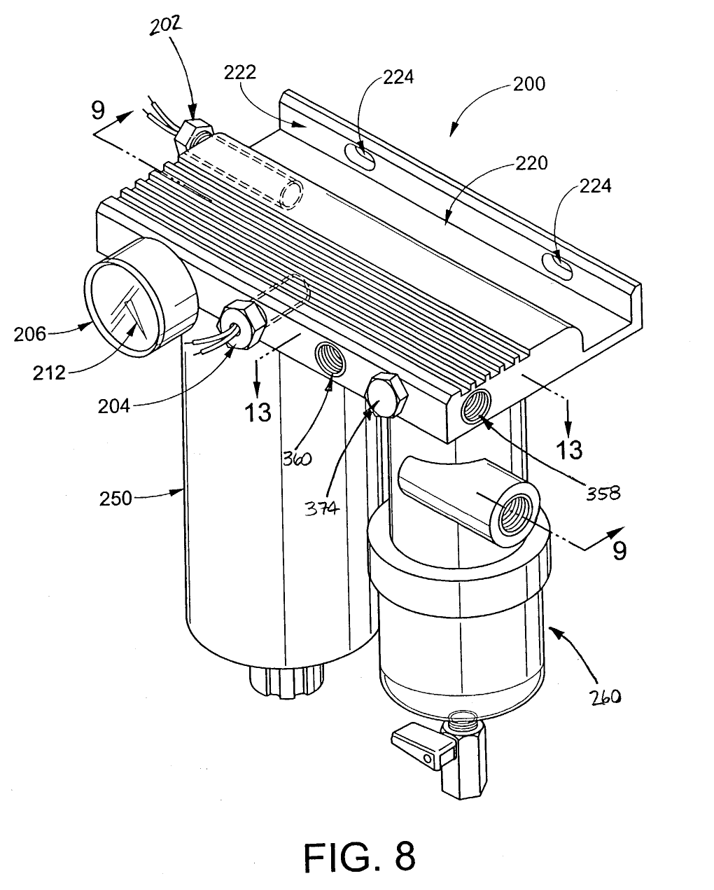

Another embodiment of a fluid treatment system 200 in accordance with the present invention is shown in FIG. 8. It will be appreciated that fluid treatment system 200 can be used in association with any suitable fluid transfer system, including, but not limited to, a system similar to transfer system TS described hereinbefore but in which treatment system 10 is replaced by treatment system 200. Treatment system 200 includes a fluid manifold or transfer rail 220, a secondary filter 250 and a primary fluid treatment apparatus 260. Transfer rail 220 includes a mounting portion or wall 222 having mounting holes 224 extending therethrough such that treatment apparatus 200 can be mounted or otherwise supported in a suitable manner, such as by threaded fasteners (not shown). It will be appreciated that one or more check valves (not shown), either internal, external or both, may be included within system 200 or the components thereof, such as treatment apparatus 260, to guard against the loss of prime, such as when the system is undergoing maintenance or other service, for example. Some engine manufacturers also employ an additional spin-on filter (not shown) on the engine for further filtration of the fuel. While this additional filter could be termed a tertiary filter, for the sake of simplicity it will be referred to as an additional secondary filter, since it is usually of the same conventional type as the secondary filter 250.

Fluid treatment system 200 also includes heating elements 202 and 204 each extending into and supported on transfer rail 220. Heating element 202 can operate using a 12-volt, direct current power source (not shown), such as a battery or regulator mounted on the associated vehicle. In contrast, heating element 204 can use a 120-volt, alternating current power source (not shown), such as is typically available from an electrical outlet of a building. As such, heating element 202 can be used to raise the temperature of transfer rail 220, and hence the fluid flowing through it, as well as other components of treatment system 200 while the treatment apparatus is in use in association with, for example, an engine of a vehicle. Heating element 204 can be used to raise the temperature of the fluid treatment apparatus 200 while the device with which the treatment apparatus is associated is not in use, such as when a vehicle is parked and the engine thereof is not running, for example.

A restriction indicator 206 is supported on transfer rail 220 adjacent secondary filter 250. One embodiment of restriction indicator 206, can include a damped restriction gauge 208 having a suitably sized faceplate 210 (FIG. 10), such as from about one inch (1″) to about three inches (3″) in diameter, for example. The gauge can include an indicator needle 212 displaceable through a range of rotational movement, such as about two hundred seventy degrees (270°), for example. Indicator needle 212 is responsive to a vacuum level, which can be measured in inches of mercury (in. Hg.), for example, that is applied to gauge 208. The gauge is adapted to accommodate vacuum levels through any suitable range, such as from about zero inches of mercury (0 in. Hg.) to about fifteen inches of mercury (15 in. Hg.), for example. The gauge can include one or more internal snubbers (not shown) to limit movement of indicator needle 212 and can also include a silicone fill to provide damping of the movement of indicator needle 212. Such damping will minimize spiking and jumping of needle 212 so that a more accurate reading of the restriction indicator can be made. Faceplate 210 is shown in FIG. 10 as having three distinct areas 214, 216 and 218 circumferentially disposed about portions of the faceplate. In the embodiment of faceplate 210 shown in FIG. 10, “safe” area 214 is green, “impending” area 216 is yellow, and “expired” area 218 is red. However, it will be appreciated that any other suitable colors, patterns, symbols or other indicia, such as numbers and/or tick marks 219, for example, can be used.

Generally, the restriction indicator 206 can provide a visual way of identifying the restriction or blockage level present in the primary filter 260 or in the one or more secondary filters 250. By monitoring the restriction indicator, an operator or service person can be alerted to a blocked or otherwise restricted particulate filter before the downstream device is effected. Monitoring the restriction indicator can prevent or minimize premature changing of the secondary filter or unnecessarily changing the filter when troubleshooting a complaint related to poor or reduced performance of an associated device, such as an engine, for example. In operation, a downstream device, such as a pump, for example, will generate a vacuum causing the fluid to be drawn through the fluid treatment system, including the secondary filter, as has been discussed in detail with regard to FIG. 2. As the restriction or blockage in the secondary filter increases, a corresponding increase in vacuum level is felt at the secondary filter as the vacuum generator attempts to maintain fluid flow through the fluid treatment system. The restriction indicator is fluidically positioned between the secondary filter and the downstream vacuum generator and provides a visual indication of the vacuum level. As the restriction and corresponding vacuum levels increase, indicator needle 212 is displaced on gauge 208 reflecting the increased vacuum level. Indicator needle 212 will move from green or “safe” area 214 toward red or “expired” area 218, at which point the secondary filter should be replaced. The visual indicator portion of the gauge can be located on transfer rail 220 as shown in FIG. 8, or in any other suitable and convenient location, such as on the dashboard of a vehicle, for example. It will be appreciated that restriction indicator 206 and the components thereof can be included in a suitable manner with all embodiments of the present invention.

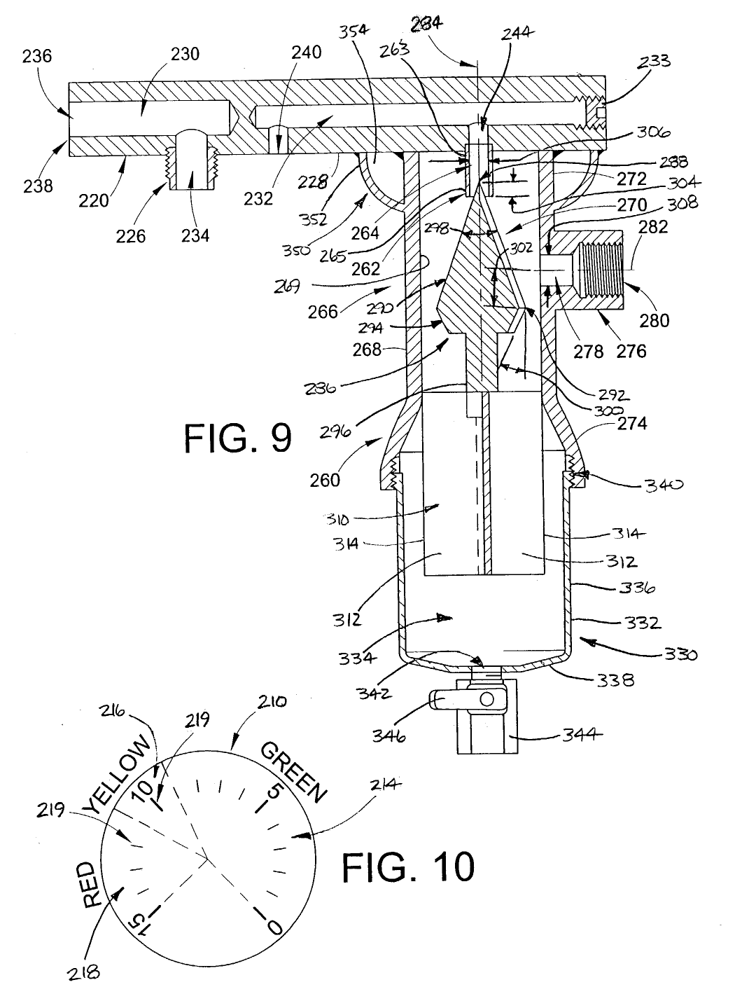

FIG. 9 shows a cross-sectional view of transfer rail 220 and fluid treatment apparatus 260 that is supported on the transfer rail. A filter adaptor 226 extends from bottom surface 228 of transfer rail 220. The transfer rail includes discharge passage 230 and transfer passage 232. An adaptor passage 234 extends through filter adaptor 226 and is in fluid communication with one end of discharge passage 230. The discharge passage extends through the transfer rail to discharge opening 236 in side wall 238. Transfer passage 232 extends between a delivery opening 244 in fluid communication with a pickup passage 264 of a pickup tube 262 and a filter supply opening 240 suitable for delivering treated fluid from treatment apparatus 260 through transfer passage 232 to secondary filter 250 (shown in FIG. 8). Pickup tube 262 has a distal end 263 adjacent bottom wall 228 and a proximal end 265 spaced from the bottom wall. It will be appreciated that passage 232 is preferably fluid tight, apart from opening 240 and passage 264. As such, a plug 233 is installed in the distal end of passage 232.

Fluid treatment apparatus 260 includes a housing 266 having a cylindrical housing wall 268 defining a separation or treatment chamber 270. Housing wall 268 extends between a upper end 272 adjacent bottom surface 228 of transfer rail 220 and a lower end 274 spaced away from the transfer rail. The upper end of housing 266 is suitably supported on transfer rail 220, such as by welding the upper end 272 to bottom surface 228. It will be appreciated, however, that any suitable method of attaching or supporting treatment apparatus 260 on transfer rail 220 can be used, such as a threaded connection, for example. A supply stem 276 extends from housing 266 and includes a fluid supply passage 278 having a threaded portion 280 extending therethrough in tangential relation to an inside surface 269 of housing wall 268. Supply passage 278 has a centerline 282 that is generally transverse to and radially spaced from a centerline 284 of housing 266. It will be appreciated that passage 264 of pickup tube 262 is disposed centrally within housing 266 along centerline 284. A separation cone 286 is supported centrally within treatment chamber 270 of housing 266. Cone 286 has a vertex 288, a first conical wall portion 290 extending from vertex 288 to an area of maximum diameter 292. A second conical wall portion 294 extends from the area of maximum diameter away from first wall portion 290 toward a support stem 296. The stem supports separation cone 286 within treatment chamber 270 via a vortex breaker 310.

First conical wall portion 290 of separation cone 286 extends from vertex 288 at an included angle 298 of from about 30° to about 50°. An included angle 298 of about 40° is shown in FIG. 9. From about the area of maximum diameter 292, second conical wall portion 294 extends away from vertex 288 at an angle 300 of from about 20° to about 40°. An angle at about 30° is shown in FIG. 9. Separation cone 286 is positioned within treatment chamber 270 such that a distance 302 between the area of maximum diameter 292 and the centerline 282 of supply passage 278 is from about 3/8 of an inch to about 7/8 of an inch. A distance of about 5/8 of an inch is shown in FIG. 9. Additionally, vertex 288 of separation cone 286 extends into pickup passage 264 of pickup tube 262 from proximal end 265 a distance 304 of from about 1/64 of an inch to about 1/2 of an inch. In FIG. 9, a distance of about 1/4 of an inch is shown. Pickup passage 264 of pickup tube 262 has an inside diameter 306 of from about 1/4 of an inch to about 3/4 of an inch. It is shown in FIG. 9 as having an inside diameter 306 of about 7/16 of an inch. Fluid supply passage 278 has an inside diameter 308 of from about 1/4 of an inch to about 3/4 of an inch and is shown in FIG. 9 as having an inside diameter 308 of about 1/2 an inch.

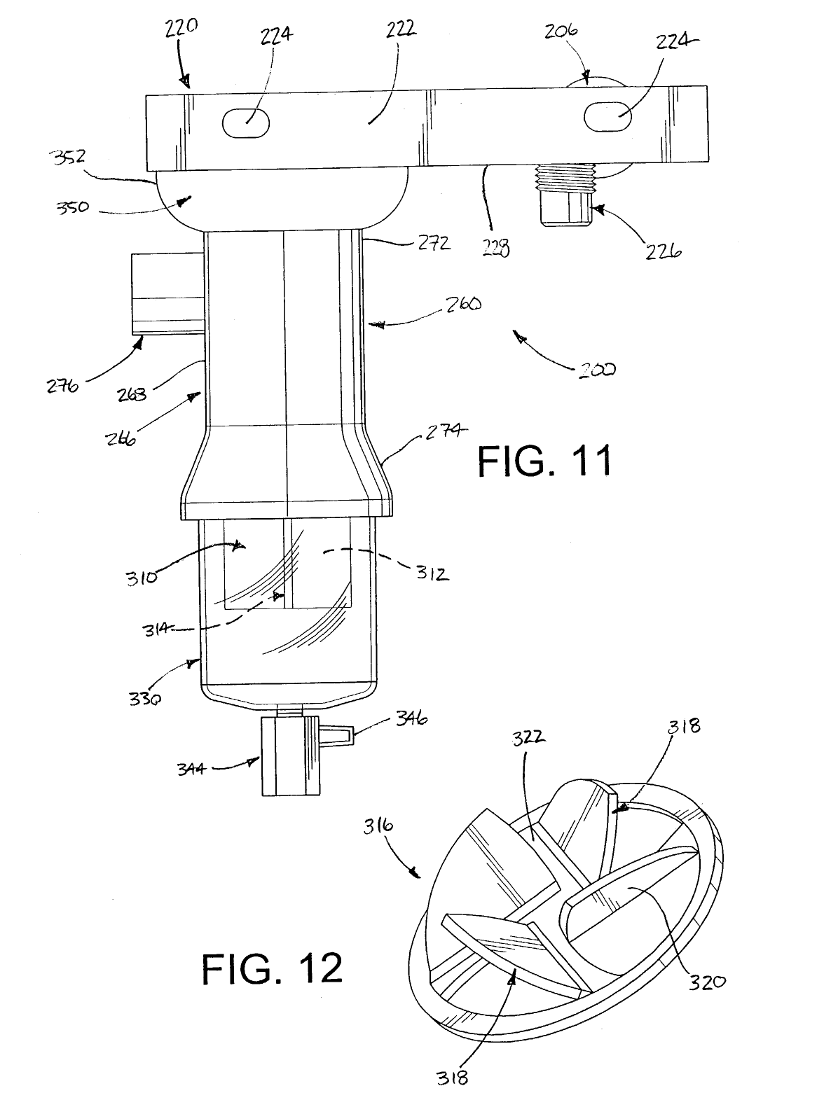

As mentioned, separation cone 286 is supported within treatment chamber 270 on a vortex breaker 310. In turn, the vortex breaker is supported on housing 266. Vortex breaker 310 includes a plurality of counter-flow surfaces 312 each formed of a longitudinal wall 314. The walls extend outwardly in a generally cruciform shape. In this embodiment, vortex breaker 310 includes four elongated walls each having two opposing counter-flow surfaces on each wall. However, it will be appreciated that other suitable number of walls and corresponding surfaces can be used without departing from the principles of the present invention. For example, FIG. 12 shows a vortex breaker 316, which includes walls 318 each having a counter-flow surface 320 and extending from a support body 322 that has a generally disk-like shape. This embodiment of a vortex breaker 316 is positioned within treatment chamber 270 and mounted to housing 266 such that walls 318 extend from support body 322 in a direction away from separation cone 286. It will be further appreciated that other suitable vortex breakers can be provided having one or more counter-flow surfaces, and that the present invention is not intended to be limited to the examples of vortex breakers 310 and 316 shown and described herein. All that is required is a set of surfaces that stop or counter-rotate the swirling motion of the fluid and its entrained particles, allowing gravity to pull the particles and heavier fluids into a collection cup.

As shown in FIGS. 9 and 11, a collection cup 330 is supported on housing 266 adjacent lower end 274 thereof. Collection cup 330 receives and retains water and other immiscible fluids as well as foreign particles that are separated from the fluid being treated. Collection cup 330 is formed from at least one wall 332 defining a collection cavity 334 into which a portion of vortex breaker 310 or 316 can extend. Wall 332 has a side wall portion 336 and a bottom wall portion 338 and can be formed from any suitable material including transparent materials, such as plastic or glass, for example. Collection cup 330 can be supported on housing 270 in any suitable manner, such as by using a male and female thread arrangement 340, for example. A purge passage 342 extends through bottom wall portion 338. Passage 342 is outfitted with a purge valve 344 which forms a fluid-tight seal with bottom wall portion 338 to permit the selective evacuation of the water and other immiscible fluids as well as foreign particles from collection cavity 334. Purge valve 344 is shown in FIGS. 9 and 11 as having a handle 346 for manually opening and closing the valve such that cavity 334 can be drained on an as-needed basis. It will be appreciated that the valve may be opened and closed by remote actuation or automatically, for example, in response to level sensors responsive to the quantity of fluids and particles in collection cavity 334.

Fluid treatment apparatus 260 can optionally include a heating jacket 350 that uses heated fluid, such as engine coolant, for example, to provide heat to housing 266 of fluid treatment apparatus 260. Heating jacket 350 includes a jacket wall 352 that extends between housing wall 268 and bottom surface 228 of transfer rail 220. A fluid-tight heating cavity 354 is formed between the jacket wall, housing wall 268 and bottom surface 228 of the transfer rail. The heating cavity extends generally about the exterior of housing 266 such that heating fluid flowing through cavity 354 transfers heat to housing wall 268 and transfer rail 220. It will be appreciated that jacket wall 352 forms a fluid-tight connection with housing wall 268 and bottom surface 228 of transfer rail 220 in any suitable manner, such as by welding, for example.

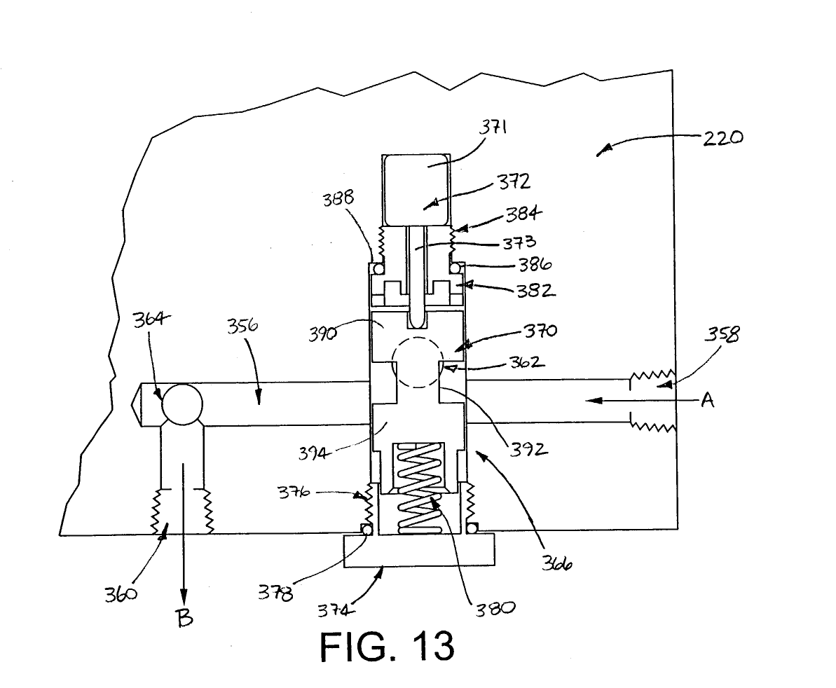

As can be better seen in FIG. 13, transfer rail 220 includes a heating fluid passage 356 that includes heating fluid supply port 358 and heating fluid discharge port 360, and the heating fluid flows into supply port 358 as indicated by arrow A and flows out of discharge port 360 as indicated by arrow B. A heating cavity inlet passage 362 is provided along fluid passage 356 and supplies heating fluid to heating cavity 354. A heating cavity outlet passage 364 is provided along fluid passage 356 for the discharge of heating fluid from the heating cavity. A valve arrangement 366 is disposed along fluid passage 356 between supply port 358 and discharge port 360. A valve chamber 368 is provided in transfer rail 220 and in fluid communication with heating fluid passage 356 and houses valve arrangement 366. The valve arrangement includes a valve body 370 axially captured between a thermally activated linear actuator 372 housed within the valve chamber and an end cap 374 supported on transfer rail 220 along valve chamber 368 by a thread arrangement 376. A sealing member, such as an o-ring 378, for example, is compressively positioned between the end cap and the transfer rail forming a fluid-tight seal therewith. Thermally activated linear actuator 372 includes a wax pill (not shown) contained in an actuator body 371 that expands with increased temperatures causing an actuator rod 373 to be displaced outwardly from actuator body 371. It will be appreciated, however, that any suitable thermally activated or thermally responsive arrangement can be used. A spring member, such as a compression spring 380, for example, is disposed between end cap 374 and valve body 370 biasing the valve body toward actuator 372. An intermediate member 382 captures actuator 372 within valve chamber 368 using a thread arrangement 384 in cooperation with transfer rail 220. A sealing member, such as an o-ring 386, for example, is compressively positioned between intermediate member 382 and a shoulder 388 provided in valve chamber 368 for forming a fluid-tight seal therebetween. Valve body 370 includes a first end portion 390, a central portion 392 and a second end portion 394 opposite first end portion 390.

Valve body 370 is shown in FIG. 13 in a generally open position providing access for heating fluid to inlet passage 362. Such would be the position of valve body 370 when fluid treatment apparatus 260 is relatively cold, such as when an associated vehicle has not been running for an extended period of time, for example. As thermally activated linear actuator 372 becomes warm due to the passage of heated fluid through passage 356 as well as the heating of transfer rail 220 from the passage of warm fluid therethrough, actuator rod 373 begins extending from actuator body 371 forcing valve body 370 toward end cap 374 compressing spring 380. As valve body 370 moves toward end cap 374, first end portion 390 begins covering inlet passage 362 and, as such, more heating fluid bypasses the heating cavity of treatment apparatus 260 and flows directly through fluid passage 356 and out discharge port 360. By the time the fluid treatment apparatus 260 and the transfer rail 220 are sufficiently heated, the first end portion has substantially covered inlet passage 362 and heating fluid is primarily flowing through passage 356. It will be appreciated that valve body 370 will move between a generally open position in which heating fluid flows significantly through inlet passage 362 and heating cavity 354 and a substantially closed position in which a significantly reduced quantity of heating fluid flows through inlet passage 362 and heating cavity 354, instead flowing directly through fluid passage 356.

The embodiment illustrated in FIGS. 8-11 has been found to be particularly useful for diesel fuel powered trucks in classes 6-8. It has been found to extend the life of conventional spin-on fuel filters (such as secondary filter 250). Typically, the extended filter life can average over 100,000 miles, the goal being to have one filter change a year. The primary filter 260 removes a large proportion of the water and particulate contaminants present in the fuel before they reach the one or more secondary filters 250, thus protecting it from premature contamination. Extended secondary filter life translates into reduced operating costs and less down time for the truck.

It has been found that the primary filter 260 urges water and sediment sized 10 microns or larger outwardly in the treatment chamber 270. In this fashion, up to 97% of the water and sediment or contaminants are removed from the fuel before it reaches the secondary filter 250. As the fuel rotates in the vortex, the heavier water and particulate matter flow outward and downward toward the counter-rotational vortex breaker 310. Fluid impacts the vortex breaker, which initiates a momentary counter-rotational force, causing the remaining debris to fall out and settle in the collection cup 330. The cyclonic action creates a vortex of clean fuel at the center of the treatment chamber 270. This sweet spot of fuel is then drawn upward through the pick up tube 262.

The transfer rail 220 can be made from solid billet aluminum to eliminate porosity problems inherent in cast units. The compact size of the fluid treatment system 200 allows easy mounting in most types of truck engine compartments.

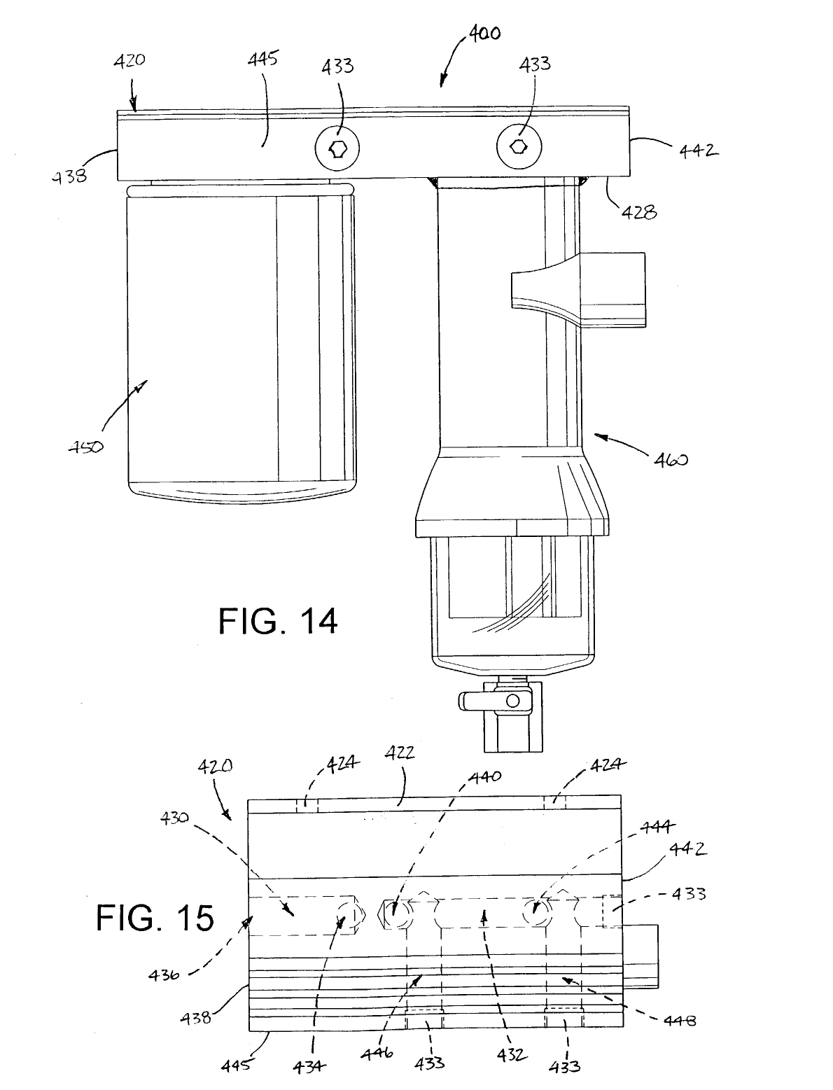

A further embodiment of a fluid treatment apparatus 400 in accordance with the present invention is shown in FIGS. 14 and 15. Fluid treatment apparatus 400 includes a fluid manifold or transfer rail 420, a secondary filter 450 and a fluid treatment apparatus 460. It will be appreciated that fluid treatment apparatus 400 is substantially similar to treatment apparatus 200 discussed hereinbefore. As such, items shown and described in one embodiment, but having no counterpart in the other embodiment, will be distinctly pointed out and discussed where appropriate. It will be appreciated that various features and/or elements shown in one embodiment are generally suitable for use in other embodiments though such features and/or elements may not otherwise be shown therein.

Transfer rail 420 includes a mounting portion 422 having mounting holes 424 extending therethrough for suitably attaching the transfer rail to a support, such as an engine or frame rail, for example. Transfer rail 420 has a bottom surface 428 on which filter 450 and treatment apparatus 460 are suitably supported. Transfer rail 420 includes a discharge passage 430 and a transfer passage 432. A suitable adaptor passage 434 extends from bottom surface 428 through transfer rail 420 to discharge passage 430, in a manner discussed hereinbefore with regard to transfer rail 220. Discharge passage 430 extends through transfer rail 420 to discharge opening 436 in side wall 438. Transfer passage 432 extends into transfer rail 420 from side wall 442 and receives a plug 433 adjacent side wall 442 forming a fluid-tight seal along passage 432. An outlet opening 440 and an inlet opening 444 are provided in transfer passage 432. Back-flush passages 446 and 448 are provided in transfer rail 420 and extend from front wall 445 into transfer passage 432. During normal operation, back-flush passages 446 and 448 each receive a plug 433 forming a fluid-tight seal therealong. During a back-flush operation, the plugs can be removed and a suitable fluid made to flow through these passages such that scale and other contaminants can be flushed from the passages.

Secondary or spin-on filter 450 can be supported on transfer rail 420 in any suitable known manner. One possible use of fluid treatment apparatus 400 is removing particulates and other foreign matter as well as immiscible fluids from engine coolant used in a vehicle. In such case, secondary filter 450 can be a typical particulate filter or can be a “charged” filter with the filter element therein being impregnated with a known coolant additive, such as a silicone coolant additive, for example, to protect the material from which the radiator and other components are formed from corrosion, as well as to minimize cavitation and erosion.

It will be appreciated that fluid treatment apparatus 460 is substantially identical to treatment apparatus 260 discussed herein before with regard to FIGS. 8, 9 and 11. As such, a detailed discussion of fluid treatment apparatus 460 is not provided. Treatment apparatus 460 is supported on bottom surface 428 in any suitable manner, such as welding, for example. However, it will be appreciated that other mounting arrangements can be used such as a threaded arrangement, for example. It will be further appreciated that fluid treatment apparatus 460 is shown in FIG. 15 without an optional heating jacket such as heating jacket 350 shown and discussed with regard to FIGS. 9 and 11. It will also be appreciated that one or more check valves (not shown), either internal, external or both, may be included within system 400 or the components thereof, such as treatment apparatus 460, to guard against the loss of prime, such as when the system is undergoing maintenance or other service, for example.

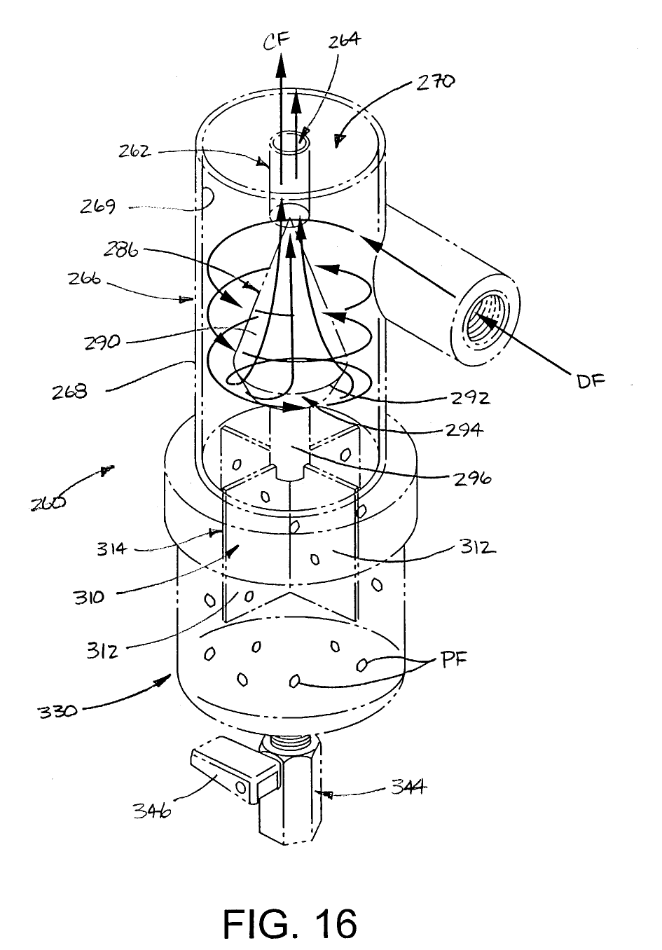

FIG. 16 illustrates fluid flow through a fluid treatment apparatus in accordance with the present invention, such as treatment apparatuses 260 and 460. FIG. 16 will be discussed using the item numbers for fluid treatment apparatus 260. However, it will be understood that this discussion is equally applicable to fluid treatment apparatus 460 shown and described with regard to FIG. 14.

“Dirty” fluid DF flows into fluid treatment apparatus 260 through fluid supply passage 278 in supply stem 276. Supply passage 278 extends through housing wall 268 in a generally tangential manner such that “dirty” fluid DF initiates cyclonic flow upon entering treatment chamber 270. The “dirty” fluid circulates along inside surface 269 of housing wall 268. Gravity causes the fluid to descend from the entry point at supply passage 278 downwardly into treatment chamber 270. Depending upon the proportional size, relative positions and fluid flow rate, as well as other factors, the “dirty” fluid can make from less than one turn around inside surface 269 to several turns around the inside surface before reaching area of maximum diameter 292 of separation cone 286. As the “dirty” fluid circulates around inside surface 269, heavier foreign particles, including those 10 microns in size and larger, and immiscible fluids are urged toward the outside of the fluid flow adjacent inside wall 269. The “clean” fluid toward the inside of the flow engages separation cone 286 adjacent area of maximum diameter 292, and the “clean” fluid is drawn upward along the exterior surface of second conical wall portion 294 and first conical wall portion 290 toward vertex 288 and into pickup passage 264 of pickup tube 262. As the “dirty” fluid flows downward toward area of maximum diameter 292, the “dirty” fluid can drop below area 292 and flow cyclonically along second conical wall portion 294 before flowing back up over area 292 and upward along first conical wall portion 290 toward vertex 288. While flowing along second portion 294, the foreign particles and immiscible fluids drop into collection cup 330 leaving “clean” fluid CF flowing upward along first portion 290. From pickup passage 264, “clean” fluid CF is delivered through delivery opening 244 into transfer passage 232 and through filter supply opening 240 to secondary filter 250. The foreign particulates and immiscible fluids separated from now “clean” fluid CF fall downward toward collection cup 330 and pass through vortex breaker 310 engaging counter-surfaces 312 which stop or significantly reduce the cyclonic flow of particulates PF and other immiscible fluids that are received in collection cup 330.

It will be appreciated that fluid treatment systems 200 and 400 generally operate under a vacuum or suction condition, however, it may be possible to use a fluid treatment system in accordance with the present invention under a positive pressure in suitable conditions without departing from the principles of the present invention. As such, a downstream device, such as transfer pump TP shown in FIG. 2, generates a vacuum along a suitable supply line connected to discharge opening 236 of transfer rail 220. The vacuum draws fluid from an upstream supply source, such as supply tank ST shown in FIG. 2, for example, along a suitable delivery line to supply passage 278 of fluid treatment apparatus 260. The vacuum draws fluid from the supply passage into treatment chamber 270 and out of pickup passage 264 as discussed above with regard to FIG. 16. The vacuum draws “clean” fluid out of pickup passage 264 along transfer passage 230 and into secondary filter 250 through filter supply opening 240. The fluid is drawn through secondary filter 250 and the remaining particulates are substantially removed thereby, and the fluid is then drawn out of the secondary filter through adapter passage 234, into discharge passage 232 and out discharge opening 236 toward the downstream device generating the vacuum.

It will be appreciated that the use of a primary fluid treatment apparatus using cyclonic separation action, such as apparatuses 60, 260 and 460, as described in detail hereinbefore, minimizes the clogging of a secondary filter, such as filters 40, 250 and 450, and thereby extends the life thereof. One benefit of extending secondary filter life is that the frequency of introduction of priming fluid into the fluid system (with the priming of the secondary filter) is reduced. Whenever a filter is primed, there is a risk of contaminating the new filter with fluid that is itself contaminated. Thus, a new secondary fuel filter could itself introduce contaminated fuel to the engine (by being primed with contaminated fuel) thereby possibly shortening engine life. Furthermore, devices in accordance with the present invention can remove a significant proportion of water and other contaminants before they reach the regular or secondary filter or filters. This has the beneficial effect of reducing maintenance and increasing performance of an associated downstream device, such as an engine, for example. A further benefit of fluid treatment systems in accordance with the present invention is the inclusion of a transfer rail that fosters the use of any suitable type or configuration of secondary filter as may be developed or specified by an original equipment manufacturer.

While the invention has been described with reference to preferred embodiments and considerable emphasis has been placed herein on the structure and structural interrelationships between the component parts of the embodiments disclosed, it will be appreciated that other embodiments of the invention are also contemplated many changes can be made in the embodiments illustrated and described without departing from the principles of the invention. Obviously, modifications and alterations will occur to others upon reading and understanding the preceding detailed description. Accordingly, it is to be distinctly understood that the foregoing descriptive matter is to be interpreted merely as illustrative of the present invention and not as a limitation. As such, it is intended that the invention be construed as including all such modifications and alterations insofar as they come within the scope of the appended claims and the equivalents thereof.

What is claimed is:

1. A fluid treatment apparatus comprising:
a housing including a first wall at least partially defining a particle separation chamber, a housing axis, and a fluid inlet passage extending through said housing first wall in tangential relation to said particle separation chamber;
a second wall disposed within said housing, said second wall including a conical portion, wherein said housing axis extends through said conical portion; and,
a draw tube including a tubing wall at least partially defining a fluid outlet passage, said draw tube protruding into said housing and extending generally along said housing axis.

2. A fluid treatment apparatus according to claim 1 further comprising a collection cup supported by said housing on an end of said housing opposite said draw tube.

3. A fluid treatment apparatus according to claim 1 further comprising a vortex breaker having at least one counter-flow surface, said vortex breaker being located adjacent said second wall and spaced from said draw tube.

4. A fluid treatment apparatus according to claim 1, wherein said conical portion of said second wall comprises a cone having a vertex and an area of maximum diameter.

5. A fluid treatment apparatus according to claim 1 further comprising a heater in thermal communication with said housing.

6. A fluid treatment apparatus according to claim 5, wherein said heater includes a jacket wall defining a heater cavity, and a heater inlet passage and a heater outlet passage each in fluid communication with said heater cavity.

7. A fluid treatment apparatus according to claim 1, wherein said conical portion of said second wall has a vertex and an included solid angle at said vertex of about 30 degrees to about 50 degrees.

8. A fluid treatment apparatus according to claim 1, wherein said second wall conical portion comprises an open lower end.

9. A fluid treatment apparatus according to claim 8, wherein said conical portion of said second wall has an open upper end.

10. A fluid treatment apparatus according to claim 9, wherein said upper end of said conical portion of said second wall has a larger diameter than said lower end thereof.

11. A fluid treatment apparatus for use with an internal combustion engine comprising:
a fluid manifold including a fluid passage extending therethrough;
a housing supported on said fluid manifold and including a housing wall at least partially defining a particle separation chamber, a housing central axis, and a fluid inlet passage extending through said housing wall in tangential relation to said particle separation chamber;
a separation cone supported at least partially in said housing, said separation cone cooperating with said housing wall; and,
a draw tube defining a fluid outlet passage communicating with said fluid manifold and including a proximal end located adjacent said separation cone.

12. A fluid treatment apparatus according to claim 11 further comprising a vortex breaker supported at least partially within said separation chamber adjacent said separation cone, said vortex breaker including at least one counter-flow surface.

13. A fluid treatment apparatus according to claim 11, wherein said separation cone includes a vertex.

14. A fluid treatment apparatus according to claim 13, wherein said vertex is disposed in said proximal end of said draw tube.

15. A fluid treatment apparatus according to claim 14, wherein said separation cone has an included solid angle at said vertex of about 30 degrees to about 50 degrees.

16. A fluid treatment apparatus according to claim 14, wherein said outlet passage of said draw tube has a diameter of about 1/4 inch to about 1/2 inch, and said draw tube extends over said cone vertex a distance of about 1/64 inch to about 1/2 inch.

17. A fluid treatment apparatus according to claim 11 further comprising a restriction indicator supported on said fluid manifold and in fluid communication with said fluid passage, said restriction indicator being responsive to a flow characteristic of fluid flow through said fluid passage.

18. A fluid treatment apparatus according to claim 11, wherein said fluid inlet passage is positioned a distance of about 3/8 inch to about 7/8 inch from a widest diameter portion of said separation cone.

19. A fluid treatment apparatus according to claim 11 further comprising a particulate filter selectively supported on said fluid manifold in spaced relation to said housing.

20. A fluid treatment apparatus comprising:
a fluid manifold including a fluid passage therein;
a fluid filter selectively supported on said fluid manifold;
a housing supported on said fluid manifold in spaced relation to said fluid filter, said housing including a wall cooperating with a conical structure at least partially located in said housing to define a particle separation chamber including a generally vertically extending axis, said housing further including a fluid inlet passage extending through said housing wall in a generally tangential relation with said separation chamber such that fluid passing through said fluid inlet passage undergoes cyclonic flow in said separation chamber;
a vortex breaker supported at least partially in said housing, said vortex breaker including a body portion and at least one counter-flow surface extending from said body portion; and,
a collection cup supported by said housing for holding particulate matter separated from the fluid.

21. A fluid treatment apparatus according to claim 20 further comprising a restriction indicator supported on said fluid manifold and in fluid communication with said fluid passage thereof, said restriction indicator responsive to a flow characteristic of fluid flow through said fluid passage.

22. A fluid treatment apparatus according to claim 20 further comprising a draw tube for leading cleaned fluid from said housing to said fluid manifold.

23. A fluid treatment apparatus for an internal combustion engine of a vehicle comprising:
a fluid supply line leading from a fluid supply tank of an associated engine;
a fluid pretreatment device communicating with said fluid supply line, said fluid pretreatment device comprising:
a housing including a wall;
a conical structure extending in said housing, wherein said wall of said housing cooperates with said conical structure to define a cyclonic particle separation chamber in said housing for separating particles from a fluid flowing through the separation chamber to produce a pre-cleaned fluid;
a collection cup supported on said housing for holding the particulate matter separated from the fluid in said particle separation chamber; and,
a draw tube extending into said particle separation chamber for leading the pre-cleaned fluid back to said fluid supply line.

24. A fuel treatment apparatus according to claim 23 further comprising a fluid filter communicating with said fluid line downstream from said fluid pretreatment device.

25. A fluid treatment apparatus according to claim 23 further comprising a vortex breaker supported on said housing, said vortex breaker including at least one counter-flow surface.

26. A fluid treatment apparatus according to claim 25 wherein said vortex breaker comprises a pair of transverse counter-flow surfaces.

27. A fluid treatment apparatus according to claim 25 wherein said vortex breaker comprises four counter-flow surfaces

28. A fluid treatment apparatus according to claim 23, wherein said housing includes a fluid inlet passage extending through said wall in tangential relation to said cyclonic particle separation chamber.

29. A fluid treatment apparatus according to claim 23 further comprising a heater in thermal communication with said housing of said fluid pretreatment device.

30. A fluid treatment apparatus according to claim 23 further comprising a fluid restriction indicator responsive to a flow characteristic of fluid flow through said fluid supply line.

31. A fluid treatment apparatus according to claim 23, wherein said conical structure generally comprises a cone that includes a vertex and an area of maximum diameter, wherein said vertex is located adjacent said draw tube and said area of maximum diameter is spaced apart from said draw tube.

32. A fluid treatment apparatus according to claim 23, wherein said conical structure includes an upper end located adjacent said draw tube and a lower end spaced away from said draw tube.

33. A fluid treatment apparatus of claim 32, wherein said conical structure comprises a first portion extending from said upper end to an area of maximum diameter and a second portion extending from said area of maximum diameter to said lower end.
